(19) United States
(12) Patent Application Publication
(10) Pub. No.: US 2016/0066087 A1
(43) Pub. Date: Mar. 3, 2016

(54) JOINT NOISE SUPPRESSION AND ACOUSTIC ECHO CANCELLATION

(71) Applicants: Ludger Solbach, Mountain View, CA (US); Carlo Murgia, Sunnyvale, CA (US)

(72) Inventors: Ludger Solbach, Mountain View, CA (US); Carlo Murgia, Sunnyvale, CA (US)

(21) Appl. No.: 14/167,920

(22) Filed: Jan. 29, 2014

Related U.S. Application Data
(63) Continuation-in-part of application No. 12/215,980, filed on Jun. 30, 2008, now Pat. No. 9,185,487.

(51) Int. Cl. H04R 3/00

(52) U.S. Cl. CPC H04R 3/002

(57) ABSTRACT

Systems and methods for joint noise and echo suppression using noise and echo subtraction processing are provided. The noise subtraction processing comprises receiving at least a primary acoustic signal, a secondary acoustic signal, and an echo reference acoustic signal. A desired signal component may be calculated and subtracted from the secondary acoustic signal to obtain a noise component signal. An adjusting coefficient for the noise component signal and an adjusting coefficient for the echo reference signal may be determined and applied. The noise component signal and echo reference signal may be subtracted from the primary acoustic signal to generate a noise and echo subtracted signal. An additional echo cancellation in the noise and echo subtracted signal may be carried out by applying a nonlinear processor. The non-linear processor is driven by at least a ratio of the noise and echo subtracted signal energy and the primary acoustic signal energy.

### CROSS-REFERENCE TO RELATED APPLICATIONS

The present application is a Continuation-In-Part of U.S. application Ser. No. 12/215,980, filed Jun. 30, 2008, which is incorporated herein by reference in its entirety for all purposes.

The present application is related to U.S. patent application Ser. No. 11/825,563, filed Jul. 6, 2007 and U.S. patent application Ser. No. 12/080,115, filed Mar. 31, 2008, both of which are incorporated herein by reference.

The present application is also related to U.S. patent application Ser. No. 11/343,524, filed Jan. 30, 2006 and U.S. patent application Ser. No. 11/699,732, filed Jan. 29, 2007, both of which are incorporated herein by reference.

### FIELD

The present application relates generally to audio processing and, more particularly, to joint noise and echo suppression of an audio signal.

### BACKGROUND

Currently, there are many methods for reducing background noise and cancelling echo in an adverse audio environment. Common solutions for cancelling echo and reducing noise include treating the noise and echo separately by cascading the noise canceller with an echo canceller or vice versa. In this case, noise cancellation usually represents a linear process and utilizes a common least square method to evaluate a contribution of the noise component in an audio signal. However, the noise canceller may underestimate or overestimate the noise component due to the presence of an echo component in the audio signal. Therefore, better methods for joint cancellation of noise and echo are needed.

Many noise suppression processes calculate a masking gain and apply this masking gain to an input signal. Thus, if an audio signal is mostly noise, a masking gain that has a low value may be applied (as a multiple) to the audio signal. Conversely, if the audio signal mostly consists of a desired sound, such as speech, a high value gain mask may be applied to the audio signal. This process is commonly referred to as multiplicative noise suppression.

### SUMMARY

Embodiments of the present disclosure may overcome or substantially alleviate prior problems associated with the noise suppression and echo cancellation to enhance audio signal. In example embodiments, at least a primary acoustic, secondary acoustic, and far-end echo signals are received by a microphone array. The microphone array may comprise a close microphone array or a spread microphone array.

A noise component may be determined in each sub-band of signals received by the microphone by subtracting the primary acoustic signal weighted by a complex-valued coefficient σ from the secondary acoustic signal. The noise component signal, weighted by another complex-valued coefficient α, and echo reference component, weighted by yet another complex-valued coefficient η, may be subtracted from the primary acoustic signal resulting in an estimate of a target signal (i.e., a noise and echo subtracted signal).

The resulting noise and echo subtracted signal may be further treated by a non-linear processor to additionally remove the residual echo in the noise and echo subtracted signal. The non-linear processor may be driven by the ratio R between the noise and echo subtracted signal energy and the input energy at the primary microphone.

### BRIEF DESCRIPTION OF THE DRAWINGS

FIG. 1 is an example environment in which embodiments of the present disclosure may be practiced.

FIG. 2 is a block diagram of an example audio device implementing embodiments of the present disclosure.

FIG. 3 is a block diagram of an example audio processing system utilizing a spread microphone array.

FIG. 4 is a block diagram of an example noise suppression engine of the audio processing system of FIG. 3.

FIG. 5 is a block diagram of an example audio processing system utilizing a close microphone array.

FIG. 6 is a block diagram of an example noise suppression engine of the audio processing system of FIG. 5.

FIG. 7a is a block diagram of an example joint noise and echo subtraction engine.

FIG. 7b is a schematic illustrating the operations of the joint noise and echo subtraction engine.

FIG. 8 is a flowchart of an example method for suppressing noise and echo in an audio device.

FIG. 9 is a flowchart of an example method for performing joint noise and echo subtraction processing.

FIG. 10 is a flowchart of a method of suppressing echo in audio signal by a non-linear processor for residual echo canceller according to an example embodiment.

### DETAILED DESCRIPTION

The present disclosure provides example systems and methods for a joint noise and echo suppression in an audio signal. Embodiments attempt to balance noise suppression and echo cancellation with minimal or no speech degradation (i.e., speech loss distortion). In example embodiments, noise suppression is based on an audio source location and applies a subtractive noise and echo suppression process as opposed to a purely multiplicative noise suppression process.

Embodiments of the present disclosure may be practiced on any audio device that is configured to receive sound such as, but not limited to, cellular phones, phone handsets, headsets, and conferencing systems. While some embodiments of the present disclosure are described with reference to operation of a cellular phone, the present disclosure may be practiced with any audio device.

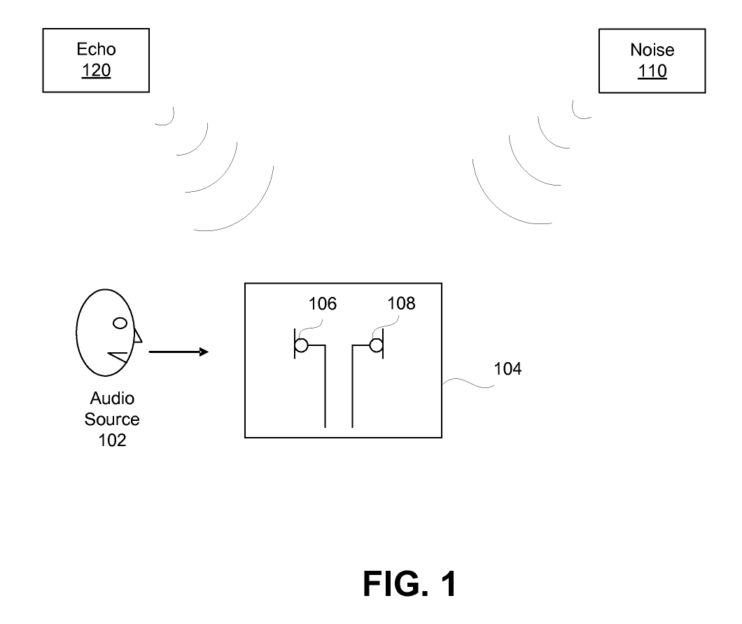

Referring now to FIG. 1, an example environment in which embodiments of the present disclosure may be practiced is shown. A user acts as a speech source 102 to an audio device 104. The example audio device 104 may include a microphone array. The microphone array may comprise a close microphone array or a spread microphone array.

In example embodiments, the microphone array may comprise a primary microphone 106 relative to the audio source 102 and a secondary microphone 108 located a distance away from the primary microphone 106. While embodiments of the present disclosure are described with regards to two microphones 106 and 108, alternative embodiments may be contemplated with any number of microphones or acoustic sensors within the microphone array. In some embodiments, the microphones 106 and 108 may comprise omni-directional microphones.

While the microphones 106 and 108 receive sound (i.e., acoustic signals) from the audio source 102, the microphones 106 and 108 may also pick up noise 110 and echo signal 120. Although the noise 110 is shown as coming from a single location in FIG. 1, the noise 110 may comprise any sounds from one or more locations different than the audio source 102. The noise 110 may be stationary, non-stationary, or a combination of both stationary and non-stationary noises.

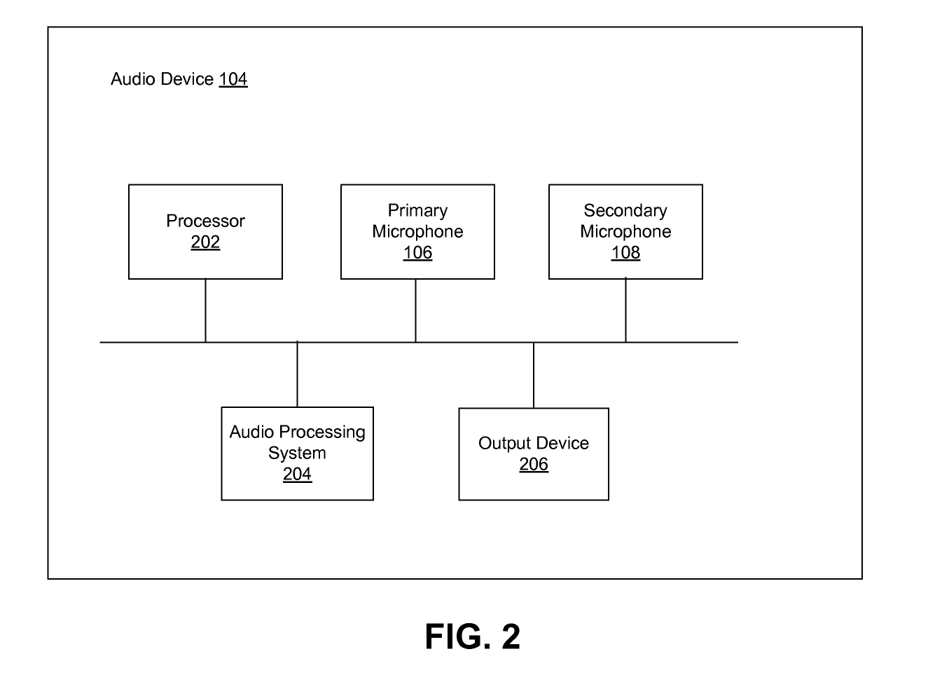

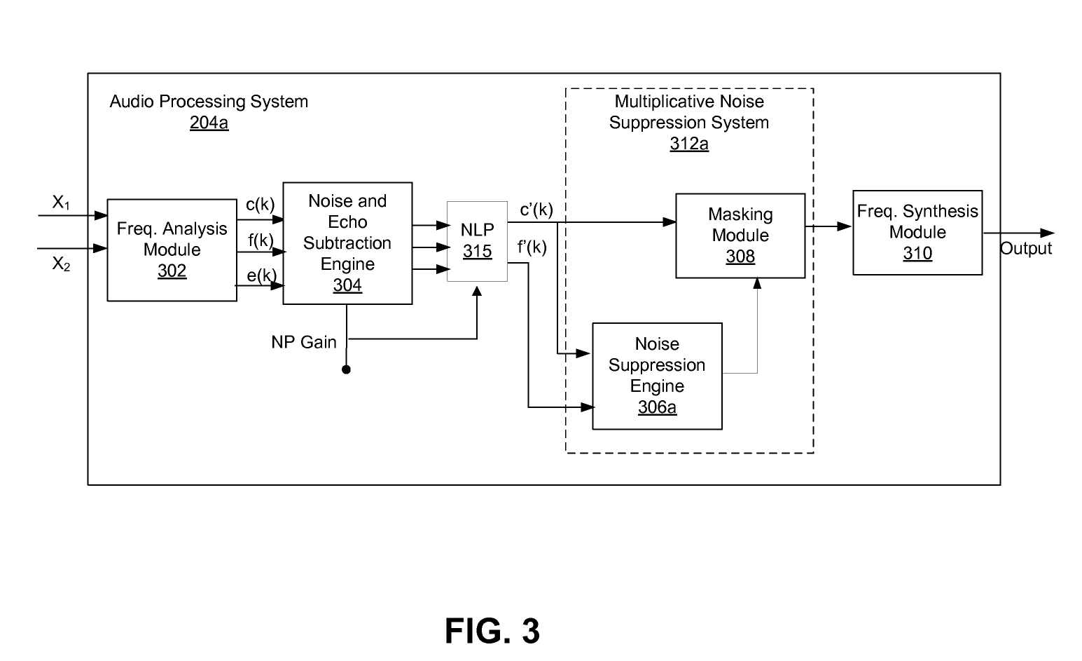

Referring now to FIG. 2, the example audio device 104 is shown in more detail. In example embodiments, the audio device 104 is an audio receiving device that comprises a processor 202, the primary microphone 106, the secondary microphone 108, an audio processing system 204, and an output device 206. The audio device 104 may comprise further components (not shown) facilitating audio device 104 operations. The audio processing system 204 is discussed in more detail below with reference to FIG. 3.

In example embodiments, the primary and secondary microphones 106 and 108 are spaced a distance apart in order to allow for an energy level difference between them. Upon reception by the microphones 106 and 108, the acoustic signals may be converted into electric signals (i.e., a primary electric signal and a secondary electric signal). The electric signals may, in turn, be converted by an analog-to-digital converter (not shown) into digital signals for processing in accordance with some embodiments. In order to differentiate the acoustic signals, the acoustic signal received by the primary microphone 106 is referred to herein as the primary acoustic signal, while the acoustic signal received by the secondary microphone 108 is referred herein to as the secondary acoustic signal.

The output device 206 is any device which provides an audio output to the user. For example, the output device 206 may comprise an earpiece of a headset or a handset, or a speaker associated with a conferencing device.

FIG. 3 is a detailed block diagram of the example audio processing system 204a according to one embodiment of the present disclosure. In example embodiments, the audio processing system 204a is embodied within a memory device. The audio processing system 204a of FIG. 3 may be utilized in embodiments comprising a spread microphone array.

In operation, the acoustic signals received from the primary and secondary microphones 106 and 108 are converted to electric signals and processed through a frequency analysis module 302. In one embodiment, the frequency analysis module 302 receives the acoustic signals and mimics the frequency analysis of the cochlea (i.e., cochlear domain) simulated by a filter bank. In one example, the frequency analysis module 302 separates the acoustic signals into frequency sub-bands. A sub-band is the result of a filtering operation on an input signal where the bandwidth of the filter is narrower than the bandwidth of the signal received by the frequency analysis module 302. Alternatively, other filters such as short-time Fourier transform (STFT), sub-band filter banks, modulated complex lapped transforms, cochlear models, wavelets, and so forth, can be used for the frequency analysis and synthesis. Because most (acoustic) sounds are complex and comprise more than one frequency, a sub-band analysis on the acoustic signal can determine what individual frequencies are present in the complex acoustic signal within a frame (e.g., a predetermined period of time). According to one embodiment, the frame is 8 ms long. Alternative embodiments may utilize other frame lengths or no frames at all. The results may comprise sub-band signals in a fast cochlea transform (FCT) domain.

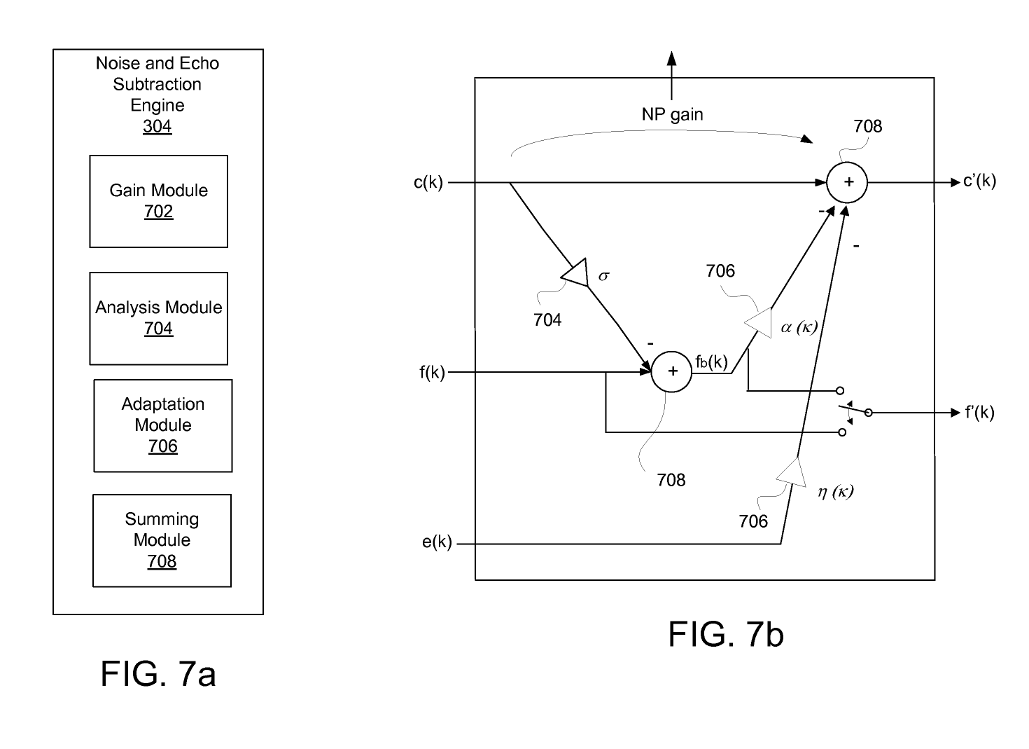

Once the sub-band signals are determined, the sub-band signals are forwarded to a noise and echo subtraction engine 304. The example noise and echo subtraction engine 304 is configured to subtract out a noise component and an echo component from the primary acoustic signal for each sub-band. As such, output of the noise subtraction engine 304 is a noise and echo subtracted signal comprising noise and echo subtracted sub-band signals. The noise and echo subtraction engine 304 is discussed in more detail below with reference to FIG. 7a and FIG. 7b.

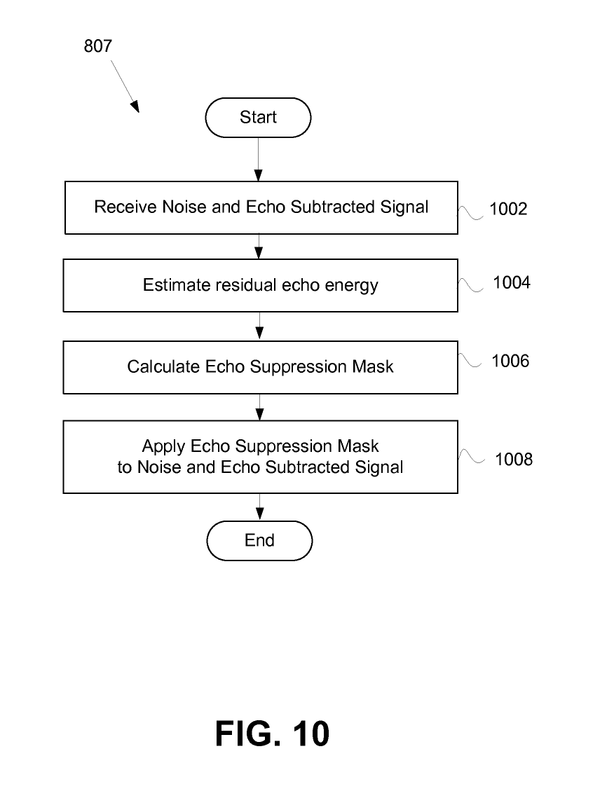

The noise and echo subtracted signal may be further passed to non-linear processor 315 for a residual echo canceller. The non-linear processor unit 315 is discussed in more detail below with reference to FIG. 10.

The results of the non-linear processor 315 may be output to the user or processed through a further noise suppression system (e.g., the noise suppression engine 306a). For purposes of illustration, embodiments of the present disclosure discuss embodiments in which the output of the noise and echo subtraction engine 304 and non-linear processor 315 is processed through a further noise suppression system.

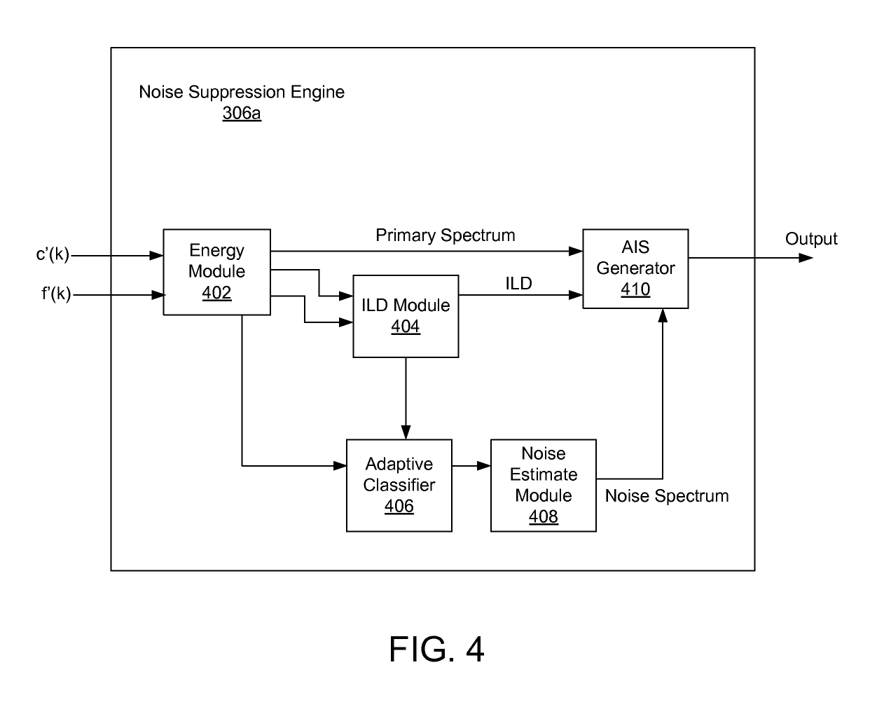

The noise and echo subtracted sub-band signals along with the sub-band signals of the secondary acoustic signal are then provided to the noise suppression engine 306a. According to example embodiments, the noise suppression engine 306a generates a gain mask to be applied to the noise subtracted sub-band signals in order to further reduce noise components that remain in the noise subtracted speech signal. The noise suppression engine 306a is discussed in more detail below with reference to FIG. 4.

The gain mask determined by the noise suppression engine 306a may then be applied to the noise subtracted signal in a masking module 308. Accordingly, each gain mask may be applied to an associated noise subtracted frequency sub-band to generate masked frequency sub-bands. As depicted in FIG. 3, a multiplicative noise suppression system 312a comprises the noise suppression engine 306a and the masking module 308.

Next, the masked frequency sub-bands are converted back into time domain from the cochlea domain. The conversion may comprise adding phase shifted signals of the cochlea channels of the masked frequency sub-bands by a frequency synthesis module 310. Alternatively, the conversion may comprise multiplying the masked frequency sub-bands by an inverse frequency of the cochlea channels by the frequency synthesis module 310. Once conversion is completed, the synthesized acoustic signal may be output to the user.

Referring now to FIG. 4, the noise suppression engine 306a of FIG. 3 is illustrated. The example noise suppression engine 306a comprises an energy module 402, an inter-microphone level difference (ILD) module 404, an adaptive classifier 406, a noise estimate module 408, and an adaptive intelligent suppression (AIS) generator 410. It should be noted that the noise suppression engine 306a is example and may comprise other combinations of modules such as shown and described in U.S. patent application Ser. No. 11/343,524, which is incorporated herein by reference.

According to an example embodiment of the present disclosure, the AIS generator 410 derives time and frequency varying gains or gain masks used by the masking module 308 to suppress noise and enhance speech in the noise subtracted signal. In order to derive the gain masks, however, specific inputs are needed for the AIS generator 410. These inputs comprise a power spectral density of noise (i.e., noise spectrum), a power spectral density of the noise subtracted signal (herein referred to as the primary spectrum), and an inter-microphone level difference (ILD).

According to example embodiment, the noise and echo subtracted signal (c′(k)) resulting from the non-linear processor 315 and the secondary acoustic signal (f′(k)) are forwarded to the energy module 402 which computes energy/power estimates during an interval of time for each frequency band (i.e., power estimates) of an acoustic signal. As can be seen in FIG. 7b, f′(k) may optionally be equal to f(k). As a result, the primary spectrum (i.e., the power spectral density of the noise and echo subtracted signal) across all frequency bands may be determined by the energy module 402. This primary spectrum may be supplied to the AIS generator 410 and the ILD module 404 (discussed in further detail below). Similarly, the energy module 402 determines a secondary spectrum (i.e., the power spectral density of the secondary acoustic signal) across all frequency bands which are also supplied to the ILD module 404. Additional details regarding the calculation of power estimates and power spectrums can be found in co-pending U.S. patent application Ser. No. 11/343,524 and co-pending U.S. patent application Ser. No. 11/699,732, which are incorporated herein by reference.

In two microphone embodiments, the power spectrums are used by an inter-microphone level difference (ILD) module 404 to determine an energy ratio between the primary and secondary microphones 106 and 108. In example embodiments, the ILD may include a time and frequency varying ILD. Because the primary and secondary microphones 106 and 108 may be oriented in a particular way, certain level differences may occur when speech is active and other level differences may occur when noise is active. The ILD is then forwarded to the adaptive classifier 406 and the AIS generator 410. More details regarding one embodiment for calculating ILD may be can be found in co-pending U.S. patent application Ser. No. 11/343,524 and co-pending U.S. patent application Ser. No. 11/699,732. In other embodiments, other forms of ILD or energy differences between the primary and secondary microphones 106 and 108 may be utilized. For example, a ratio of the energy of the primary and secondary microphones 106 and 108 may be used. It should also be noted that alternative embodiments may use cues other then ILD for adaptive classification and noise suppression (i.e., gain mask calculation). For example, noise floor thresholds may be used. As such, references to the use of ILD may be construed to be applicable to other cues.

The example adaptive classifier 406 is configured to differentiate noise and distractors (e.g., sources with a negative ILD) from speech in the acoustic signal(s) for each frequency band in each frame. The adaptive classifier 406 is considered adaptive because features (e.g., speech, noise, and distractors) change and are dependent on acoustic conditions in the environment. For example, an ILD that indicates speech in one situation may indicate noise in another situation. Therefore, the adaptive classifier 406 may adjust classification boundaries based on the ILD.

According to example embodiments, the adaptive classifier 406 differentiates noise and distractors from speech and provides the results to the noise estimate module 408 which derives the noise estimate. Initially, the adaptive classifier 406 may determine a maximum energy between channels at each frequency. Local ILDs for each frequency are also determined. A global ILD may be calculated by applying the energy to the local ILDs. Based on the newly calculated global ILD, a running average global ILD and/or a running mean and variance (i.e., global cluster) for ILD observations may be updated. Frame types may then be classified based on a position of the global ILD with respect to the global cluster. The frame types may comprise source, background, and distractors.

Once the frame types are determined, the adaptive classifier 406 may update the global average running mean and variance (i.e., cluster) for the source, background, and distractors. In one example, if the frame is classified as a source, background, or distracter, the corresponding global cluster is considered active and is moved toward the global ILD. The global source, background, and distractor global clusters that do not match the frame type are considered inactive. Source and distractor global clusters that remain inactive for a predetermined period of time may move toward the background global cluster. If the background global cluster remains inactive for a predetermined period of time, the background global cluster moves to the global average.

Once the frame types are determined, the adaptive classifier 406 may also update the local average running mean and variance (i.e., cluster) for the source, background, and distractors. The process of updating the local active and inactive clusters is similar to the process of updating the global active and inactive clusters.

Based on the position of the source and background clusters, points in the energy spectrum are classified as source or noise; this result is then passed to the noise estimate module 408.

In an alternative embodiment, an example of an adaptive classifier 406 comprises one that tracks a minimum ILD in each frequency band using a minimum statistics estimator. The classification thresholds may be placed a fixed distance (e.g., 3 dB) above the minimum ILD in each band. Alternatively, the thresholds may be placed a variable distance above the minimum ILD in each band, depending on the recently observed range of ILD values observed in each band. For example, if the observed range of ILDs is beyond 6 dB, a threshold may be placed such that it is midway between the minimum and maximum ILDs observed in each band over a certain specified period of time (e.g., 2 seconds). The adaptive classifier is further discussed in the U.S. nonprovisional application entitled “System and Method for Adaptive Intelligent Noise Suppression,” Ser. No. 11/825,563, filed Jul. 6, 2007, which is incorporated herein by reference.

In example embodiments, the noise estimate is based on the acoustic signal from the primary microphone 106 and the results from the adaptive classifier 406. The example noise estimate module 408 generates a noise estimate which is a component that can be approximated mathematically by

N(t,ω)=λ₁(t,ω)E₁(t,ω)+(1−λ₁(t,ω))min[N(t−1,ω),E₁(t,ω)]

according to one embodiment of the present disclosure. As shown, the noise estimate in this embodiment is based on minimum statistics of a current energy estimate of the primary acoustic signal, E₁(t,ω) and a noise estimate of a previous time frame, N(t−1, ω). As a result, the noise estimation is performed efficiently and with a low latency.

λI(t,ω) in the above equation may be derived from the ILD approximated by the ILD module 404, as

$${λ}_{I} ( t , ω ) = \{ \begin{matrix}\approx 0 & if ILD ( t , ω ) < threshold \\ \approx 1 & if ILD ( t , ω ) > threshold\end{matrix}$$

That is, when the primary microphone 106 is smaller than a threshold value (e.g., threshold=0.5) above which speech is expected to be, λI is small, and thus the noise estimate module 408 follows the noise closely. When ILD starts to rise (e.g., because speech is present within the large ILD region), λI increases. As a result, the noise estimate module 408 slows down the noise estimation process and the speech energy does not contribute significantly to the final noise estimate. Alternative embodiments, may contemplate other methods for determining the noise estimate or noise spectrum. The noise spectrum (i.e., noise estimates for all frequency bands of an acoustic signal) may then be forwarded to the AIS generator 410.

The AIS generator 410 receives speech energy of the primary spectrum from the energy module 402. This primary spectrum may also comprise some residual noise after processing by the noise subtraction engine 304. The AIS generator 410 may also receive the noise spectrum from the noise estimate module 408. Based on these inputs and an optional ILD from the ILD module 404, a speech spectrum may be inferred. In one embodiment, the speech spectrum is inferred by subtracting the noise estimates of the noise spectrum from the power estimates of the primary spectrum. Subsequently, the AIS generator 410 may determine gain masks to apply to the primary acoustic signal. More detailed discussion of the AIS generator 410 can be found in U.S. patent application Ser. No. 11/825,563 entitled “System and Method for Adaptive Intelligent Noise Suppression,” which is incorporated herein by reference. In example embodiments, the gain mask output from the AIS generator 410, which is time and frequency dependent, will maximize noise suppression while constraining speech loss distortion.

It should be noted that the system architecture of the noise suppression engine 306a is merely example. Alternative embodiments may comprise more components, fewer components, or equivalent components and still be within the scope of embodiments of the present disclosure. Various modules of the noise suppression engine 306a may be combined into a single module. For example, the functionalities of the ILD module 404 may be combined with the functions of the energy module 304.

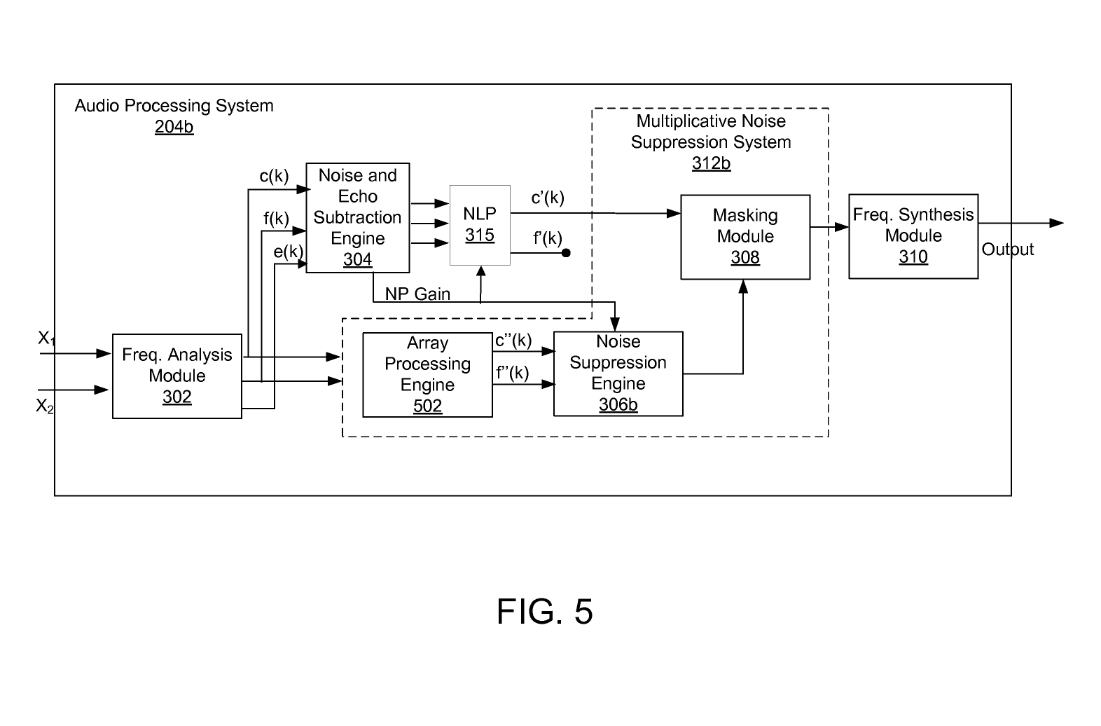

Referring now to FIG. 5, a detailed block diagram of an alternative audio processing system 204b is shown. In contrast to the audio processing system 204a of FIG. 3, the audio processing system 204b of FIG. 5 may be utilized in embodiments comprising a close microphone array. The functions of the frequency analysis module 302, masking module 308, and frequency synthesis module 310 are identical to those described with respect to the audio processing system 204a of FIG. 3 and will not be discussed in detail.

The sub-band signals determined by the frequency analysis module 302 may be forwarded to the noise and echo subtraction engine 304 and an array processing engine 502. The example noise and echo subtraction engine 304 is configured to subtract out a noise component and an echo component from the primary acoustic signal for each sub-band. As such, output of the noise and echo subtraction engine 304 is a noise and echo subtracted signal comprised of noise and echo subtracted sub-band signals. In the present embodiment, the noise and echo subtraction engine 304 also provides a null processing (NP) gain to the noise suppression engine 306a. The NP gain comprises an energy ratio indicating how much of the primary signal has been cancelled out of the noise subtracted signal. If the primary signal is dominated by noise, then NP gain will be large. In contrast, if the primary signal is dominated by speech, NP gain will be close to zero. The noise and echo subtraction engine 304 will be discussed in more detail below with reference to FIG. 7a and FIG. 7b.

The output of the noise and echo subtraction engine 304 may be passed to non-linear processor 315 for a residual echo canceller. The non-linear processor unit 315 will be discussed in more details with reference to FIG. 10.

In example embodiments, the array processing engine 502 is configured to adaptively process the sub-band signals of the primary and secondary signals to create directional patterns (i.e., synthetic directional microphone responses) for the close microphone array (e.g., the primary and secondary microphones 106 and 108). The directional patterns may comprise a forward-facing cardioid pattern based on the primary acoustic (sub-band) signals and a backward-facing cardioid pattern based on the secondary (sub-band) acoustic signal. In one embodiment, the sub-band signals may be adapted such that a null of the backward-facing cardioid pattern is directed towards the audio source 102. More details regarding the implementation and functions of the array processing engine 502 may be found (referred to as the adaptive array processing engine) in U.S. patent application Ser. No. 12/080,115 entitled “System and Method for Providing Close-Microphone Array Noise Reduction,” which is incorporated herein by reference. The cardioid signals (i.e., a signal implementing the forward-facing cardioid pattern and a signal implementing the backward-facing cardioid pattern) are then provided to the noise suppression engine 306b by the array processing engine 502.

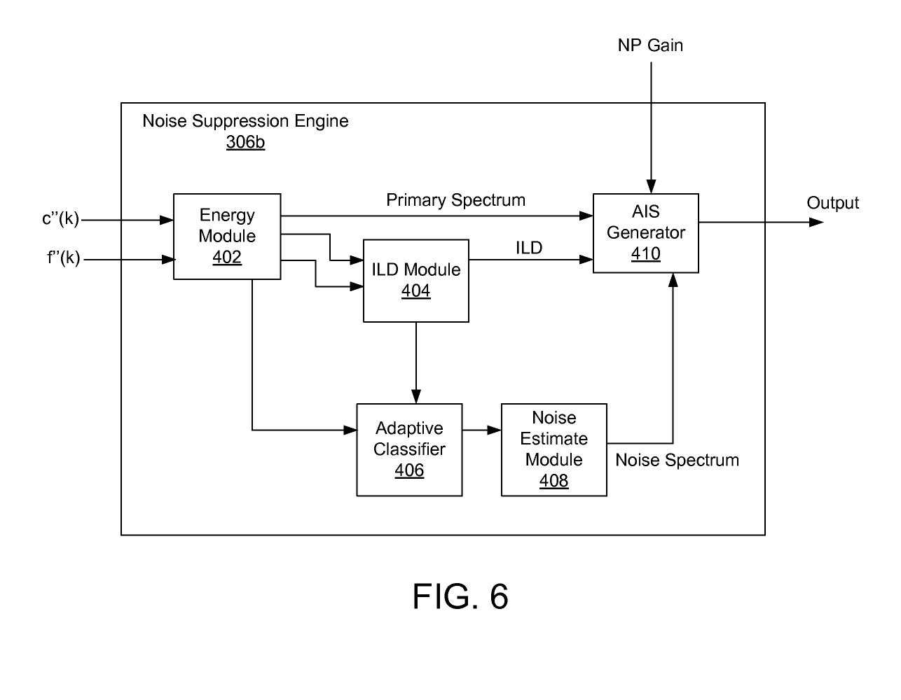

The noise suppression engine 306b receives the NP gain along with the cardioid signals. According to example embodiments, the noise suppression engine 306b generates a gain mask to be applied to the noise subtracted sub-band signals from the non-linear processor 315 in order to further reduce any noise components that may remain in the noise subtracted speech signal. The noise suppression engine 306b is discussed in more detail in connection with FIG. 6 below.

The gain mask determined by the noise suppression engine 306b may then be applied to the noise subtracted signal in the masking module 308. Accordingly, each gain mask may be applied to an associated noise subtracted frequency sub-band to generate masked frequency sub-bands. Subsequently, the masked frequency sub-bands are converted back into the time domain from the cochlea domain by the frequency synthesis module 310. Once conversion is completed, the synthesized acoustic signal may be output to the user. As depicted in FIG. 5, a multiplicative noise suppression system 312b comprises the array processing engine 502, the noise suppression engine 306b, and the masking module 308.

Referring now to FIG. 6, the example noise suppression engine 306b is shown in more detail. The example noise suppression engine 306b comprises the energy module 402, the inter-microphone level difference (ILD) module 404, the adaptive classifier 406, the noise estimate module 408, and the adaptive intelligent suppression (AIS) generator 410. It should be noted that the various modules of the noise suppression engine 306b function similar to the modules of the noise suppression engine 306a.

In the present embodiment, the primary acoustic signal (c″(k)) and the secondary acoustic signal (f″(k)) are received by the energy module 402 which computes energy/power estimates during an interval of time for each frequency band (i.e., power estimates) of an acoustic signal. As a result, the primary spectrum (i.e., the power spectral density of the primary sub-band signals) across all frequency bands may be determined by the energy module 402. This primary spectrum may be supplied to the AIS generator 410 and the ILD module 404. Similarly, the energy module 402 determines a secondary spectrum (i.e., the power spectral density of the secondary sub-band signal) across all frequency bands which are also supplied to the ILD module 404. More details regarding the calculation of power estimates and power spectrums can be found in co-pending U.S. patent application Ser. No. 11/343,524 and co-pending U.S. patent application Ser. No. 11/699,732, which are incorporated herein by reference.

As previously discussed, the power spectrums may be used by the ILD module 404 to determine an energy difference between the primary and secondary microphones 106 and 108. The ILD may then be forwarded to the adaptive classifier 406 and the AIS generator 410. In alternative embodiments, other forms of ILD or energy differences between the primary and secondary microphones 106 and 108 may be utilized. For example, a ratio of the energy of the primary and secondary microphones 106 and 108 may be used. It should also be noted that alternative embodiments may use cues other then ILD for adaptive classification and noise suppression (i.e., gain mask calculation). For example, noise floor thresholds may be used. As such, references to the use of ILD may be construed to be applicable to other cues.

The example adaptive classifier 406 and noise estimate module 408 perform the same functions as described with reference to FIG. 4. That is, the adaptive classifier differentiates noise and distractors from speech and provides the results to the noise estimate module 408 which derives the noise estimate.

The AIS generator 410 receives speech energy of the primary spectrum from the energy module 402. The AIS generator 410 may also receive the noise spectrum from the noise estimate module 408. Based on these inputs and an optional ILD from the ILD module 404, a speech spectrum may be inferred. In one embodiment, the speech spectrum is inferred by subtracting the noise estimates of the noise spectrum from the power estimates of the primary spectrum. Additionally, the AIS generator 410 uses the NP gain, which indicates how much noise has already been cancelled by the time the signal reaches the noise suppression engine 306b (i.e., the multiplicative mask) to determine gain masks to apply to the primary acoustic signal. In one example, as the NP gain increases, the estimated SNR for the inputs decreases as well. In example embodiments, the gain mask output from the AIS generator 410, which is time and frequency dependent, may maximize noise suppression while constraining speech loss distortion.

It should be noted that the system architecture of the noise suppression engine 306b is merely example. Alternative embodiments may comprise more components, fewer components, or equivalent components and still be within the scope of embodiments of the present disclosure.

FIG. 7a is a block diagram of an example noise and echo subtraction engine 304. The example noise and echo subtraction engine 304 is configured to suppress noise and echo using a subtractive process. The noise and echo subtraction engine 304 may determine a noise and echo subtracted signal by initially subtracting out a desired component (e.g., the desired speech component) from the primary signal in a first branch, thus resulting in a noise component. Adaptation may then be performed in a second branch to cancel out the noise and echo component from the primary signal. In example embodiments, the noise subtraction engine 304 comprises a gain module 702, an analysis module 704, an adaptation module 706, and at least one summing module 708 configured to perform signal subtraction. The functions of the various modules 702-708 will be discussed with reference to FIG. 7a and further illustrated in operation with reference to FIG. 7b.

Referring to FIG. 7a, the example gain module 702 is configured to determine an energy ratio (i.e., NP gain) that represents the energy ratio indicating how much noise has been canceled from the primary signal by the noise subtraction engine 304. As previously discussed, NP gain may be used by the AIS generator 410 in the close microphone embodiment to adjust the gain mask.

The example analysis module 704 is configured to perform the analysis in the first branch of the noise and echo subtraction engine 304, while the example adaptation module 706 is configured to perform the adaptation in the second branch of the noise and echo subtraction engine 304.

Referring to FIG. 7b, a schematic illustrating the operations of the noise subtraction engine 304 is shown. Sub-band signals of the primary microphone signal c(k) and secondary microphone signal f(k) are received by the noise and echo subtraction engine 304 where k represents a discrete time or a sample index. c(k) represents a superposition of a speech signal s(k), a noise signal n(k) and echo component e(k). f(k) is modeled as a superposition of the speech signal s(k), scaled by a complex-valued coefficient σ the noise signal n(k), scaled by a complex-valued coefficient ν and echo component e(k), scaled by a complex-valued coefficient μ. ν represents how much of the noise in the primary signal is in the secondary signal. μ represents how much of the echo in the primary signal in the secondary signal. In example embodiments, ν and μ is unknown since a source of the noise and the echo may be dynamic.

In example embodiments, σ is a fixed coefficient that represents a location of the speech (e.g., an audio source location). In accordance with example embodiments, σ may be determined through calibration. Tolerances may be included in the calibration based on more than one position. For a close microphone, a magnitude of σ may be close to one. For spread microphones, the magnitude of σ may be dependent on where the audio device 102 is positioned relative to the speaker's mouth. The magnitude and phase of the σ may represent an inter-channel cross-spectrum for a speaker's mouth position at a frequency represented by the respective sub-band (e.g., Cochlea tap). Because the noise subtraction engine 304 may have knowledge of what σ is, the analysis module 704 may apply σ to the primary signal (i.e., σ(s(k)+n(k)+e(k)) and subtract the result from the secondary signal (i.e., σs(k)+νn(k)+μe(k)) in order to cancel out the speech component σs(k) (i.e., the desired component) from the secondary signal resulting in a noise component out of the summing module 708.

In example embodiments, the analysis module 704 applies σ to the secondary signal f(k) and subtracts the result from c(k). Remaining signal fb(k) (referred to herein as “noise component signal”) from the summing module 708 and reference echo signal e(k) may be canceled out in the second branch by the adaptation module 706.

In example embodiments, an adjusting coefficient α for noise component signal fb(k) and an adjusting coefficient η for the reference echo signal e(k) may be found by adaptation module 706 by solving by the following matrix equation

$$( \begin{matrix}{r}_{bb} & {r}_{be} \\ {r}_{eb} & {r}_{ee}\end{matrix} ) \cdot ( \begin{matrix}α \\ η\end{matrix} ) = ( \begin{matrix}{r}_{bl} \\ {r}_{el}\end{matrix} )$$

where all quantities rij involving the blocking matrix can be derived from the current σ and the second order statistics between the two microphones and the loudspeaker reference signal as follows:

r_{bb}=r₂₂+|σ|²r₁₁−2 [symbol] {σr₂₁}

r_{b1}=r₂₁−σ*r₁₁

r_{be}=r₂ₑ−σ*r₁ₑ

r_{eb}=r_{be}^{*}

assuming

rᵢⱼ=E{xᵢ^{*}xⱼ}

wherein x₁ is the primary microphone signal c(k), x₂ is the secondary microphone signal f(k), x_{b} is noise component signal f_{b}(k), and xₑ is the reference echo signal e(k).

The matrix equation can be derived from minimizing the energy of the output signal y=c′(k)

E{y²}=r₁₁+|α|²r_{bb}+|η|²rₑₑ−(r_{1b}α+r_{b1}α*)−(r₁ₑη+rₑ₁η*)+(r_{be}α*η+r_{eb}η*α)

with respect to the two unknowns α and η.

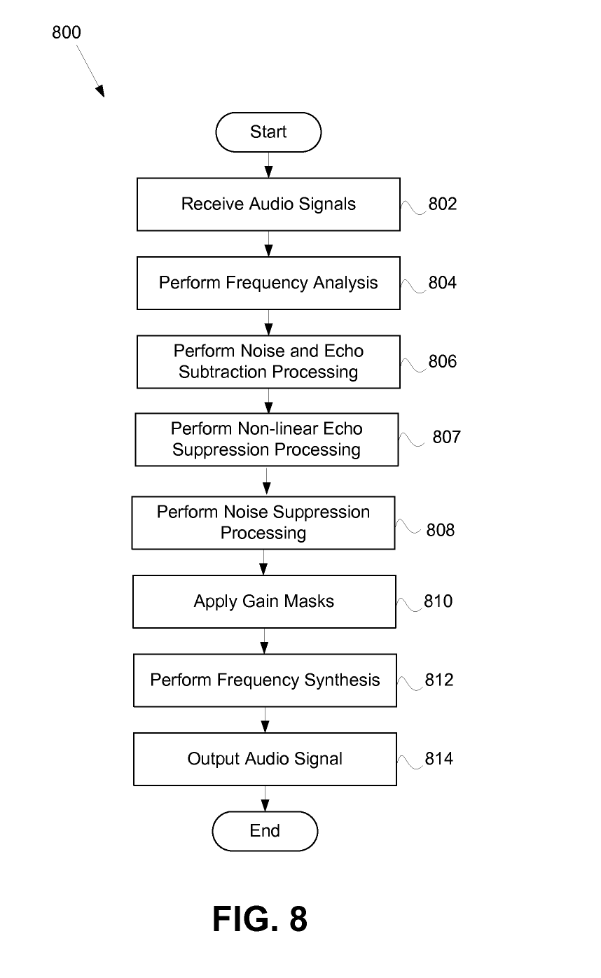

FIG. 8 is a flowchart 800 of an example method for suppressing noise and echo in an audio device. In step 802, audio signals are received by the audio device 102. In example embodiments, a plurality of microphones (e.g., primary and secondary microphones 106 and 108) receive the audio signals. The plurality of microphones may comprise a close microphone array or a spread microphone array.

In step 804, the frequency analysis on the primary and secondary acoustic signals may be performed. In one embodiment, the frequency analysis module 302 utilizes a filter bank to determine frequency sub-bands for the primary and secondary acoustic signals.

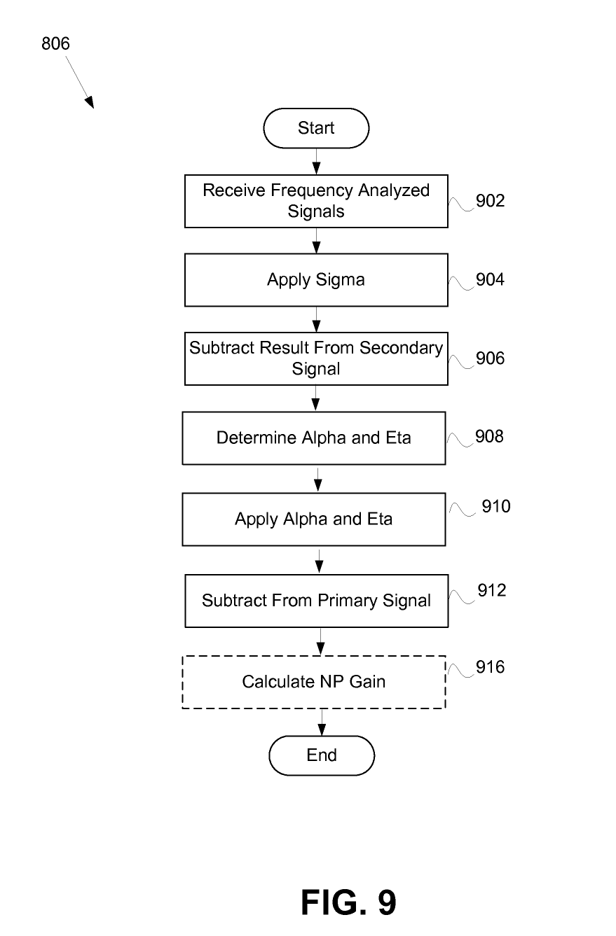

Noise and echo subtraction processing is performed in step 806. Step 806 will be discussed in more detail with reference to FIG. 9 below.

Additional cancelling of residual echo in noise and echo subtracted signal may be performed at step 807 by utilizing non-linear processor module 315. Step 807 will be discussed in more detail with reference to FIG. 10 below.

Noise suppression processing may then be performed in step 808. In one embodiment, the noise suppression processing may first compute an energy spectrum for the primary or noise subtracted signal and the secondary signal. An energy difference between the two signals may then be determined. Subsequently, the speech and noise components may be adaptively classified according to one embodiment. A noise spectrum may then be determined. In one embodiment, the noise estimate may be based on the noise component. Based on the noise estimate, a gain mask may be adaptively determined.

The gain mask may then be applied in step 810. In one embodiment, the gain mask may be applied by the masking module 308 on a per sub-band signal basis. In some embodiments, the gain mask may be applied to the noise and echo subtracted signal. The sub-bands signals may then be synthesized in step 812 to generate the output. In one embodiment, the sub-band signals may be converted back to the time domain from the frequency domain. Once converted, the audio signal may be output to the user in step 814. The output may be via a speaker, earpiece, or other similar devices.

Referring now to FIG. 9, a flowchart of an example method for performing noise and echo subtraction processing (step 806) is shown. In step 902, the frequency analyzed signals (e.g., frequency sub-band signals or primary signal) are received by the noise subtraction engine 304. The primary acoustic signal may be represented as c(k)=s(k)+n(k)+e(k) where s(k) represents the desired signal (e.g., speech signal), n(k) represents the noise signal, and e(k) represents the echo reference signal. The secondary frequency analyzed signal (e.g., secondary signal) may be represented as f(k)=σs(k)+νn(k)+μe(k).

In step 904, σ may be applied to the primary signal by the analysis module 704. The result of the application of σ to the primary signal may then be subtracted from the secondary signal in step 906 by the summing module 708. The result comprises a noise component signal. In step 908, the adjusting coefficient α for the noise component signal and the adjusting coefficient η for echo reference signal may be determined by solving matrix equation in adaptation module 706.

In step 910, α and η may be applied to the noise component and echo reference signal, respectively. The results of the application of α and η to the noise component and echo reference signal may be then subtracted from primary signal in step 912 by summing module 708. The result is a noise and echo subtracted signal. In step 918, the NP gain may be calculated. The NP gain comprises an energy ratio indicating how much of the primary signal has been cancelled out of the noise and echo subtracted signal. It should be noted that step 918 may be optional (e.g., in close microphone systems).

An NLP mask may maximize the signal-to-echo ratio (SER), and may act only in frames where a Receiver Voice Activity Detector (RX VAD) triggers the NLP mask. One important quantity for the NLP is the ratio between the subband frame energy at the canceller's input and its output, i.e. the inverse NP-Gain: Γ(k)=r_{yy}(k)/r₁₁(k). Another important quantity for the NLP is the subband frame ERL Ξ(k) at the output of the canceller, i.e. the ratio between far-end reference energy and the residual energy at the canceller output: Ξ(k)=rₑₑ(k)/r₁₁(k). In this method, a mask offset may be the sum of several components including an echo suppression enhancement, a receiver speaker volume, an echo suppression enhancement offset (in frames where a Transmitter Voice Activity Detector (TX VAD) is active), and a mask offset override. Unlike a scalar API, this may be specified as a vector with one value per subband.

FIG. 10 is a flowchart diagram of method for additional echo suppression processing (step 807) that can be performed by non-linear processor 315 for a residual echo canceller. The non-linear processor 315 may receive the noise and echo subtracted signal produced by noise and echo suppression engine 304 in step 1002. In step 1004, a residual echo subband energy can be estimated. The residual echo subband energy can be estimated as

rᵣᵣ(k)=min(r_{yy}(k),rₑₑ(k)·10^{(Ξ}^{_{dB}}^{(k)+m}^{_{dB}}^{)/10})

where m_{dB} is a mask offset and Ξ_{dB}(k) is an update for echo return loss. The update for the echo return loss can be calculated as follows:

$${Ξ}_{dB} ( k ) = \{ \begin{matrix}txVad > 0 \text{:} {Ξ}_{dB} ( k - l ) + λ ( k - l ) \cdot ( 10 \cdot {log}_{10} ( \frac{{r}_{yy} ( k - l )}{{r}_{ee} ( k - l )} ) - {Ξ}_{dB} ( k - l ) ) \\ txVad = 0 \text{:} max ( \begin{matrix}10 \cdot {log}_{10} ( \frac{{r}_{yy} ( k - l )}{{r}_{ee} ( k - l )} ) , \\ {Ξ}_{dB} ( k - l ) + λ \cdot ( 10 \cdot {log}_{10} ( \frac{{r}_{yy} ( k - l )}{{r}_{ee} ( k - l )} ) - {Ξ}_{dB} ( k - l ) )\end{matrix} )\end{matrix}$$

wherein λ is a time constant defined by the following formula:

$$λ ( k ) = {λ}_{0} ( k ) \cdot ( l - \frac{{r}_{yy} ( k )}{{r}_{ll} ( k )} )$$

and txVad is a variable showing level of a voice activity detector. An echo suppression mask m(k) can be calculated in step 1006 and applied to the noise and echo subtracted signal in step 108.

The echo suppression mask m(k) in each sub-band can be calculated using the noise and echo canceller output subband energy r_{yy}(k) and the residual echo subband energy estimate rrr(k) and can be derived using the Wiener formula:

$$m ( k ) = \frac{\hat{S} ( k )}{\hat{S} ( k ) + {r}_{rr} ( k )}$$

with

Ŝ=mₘ²(k−1)·r_{yy}(k−1)+λ_{w}·(r_{yy}(k)−rᵣᵣ(k)−mₘ²(k−1)·r_{yy}(k−1))

wherein mₘ(k) is the mask m(k) of the previous subband frame following Spectral Median Filtering and Lower-Limiting. In the Spectral Median Filtering, in each frame, a median filter is applied in the Cochlea subband dimension to the mask obtained from the sigmoid operation. This achieves the suppression of spectrally isolated ‘blips’, also known as ‘musical noise’. In Lower-Limiting, subbands that have a mask that would make the post-mask energy smaller than the selfNoise estimate offset by the API parameter aecComfortNoiseLevel_dB are lower-bounded by that level.

The above-described modules may be comprised of instructions that are stored in storage media such as a machine readable medium (e.g., a computer readable medium). The instructions may be retrieved and executed by the processor 202. Some examples of instructions include software, program code, and firmware. Some examples of storage media comprise memory devices and integrated circuits. The instructions are operational when executed by the processor 202 to direct the processor 202 to operate in accordance with embodiments of the present disclosure. Those skilled in the art are familiar with instructions, processors, and storage media.

The present disclosure is described above with reference to example embodiments. It will be apparent to those skilled in the art that various modifications may be made and other embodiments may be used without departing from the broader scope of the present disclosure. For example, the microphone array discussed herein comprises a primary and secondary microphone 106 and 108. However, alternative embodiments may contemplate utilizing more microphones in the microphone array. Therefore, there and other variations upon the example embodiments are intended to be covered by the present disclosure.

What is claimed is:

1. A method for joint suppressing noise and echo, the method comprising:
receiving at least a primary acoustic signal and a secondary acoustic signal;
receiving an echo reference signal;
subtracting a desired signal component from the secondary acoustic signal to obtain a noise component signal;
determining a first adjusting coefficient for the noise component signal and a second adjusting coefficient for the echo reference signal;
applying the first adjusting coefficient to the noise component signal to form an adjusted noise component signal;
applying the second adjusting coefficient to the echo reference signal to form an adjusted echo reference signal;
subtracting the adjusted noise component signal and the adjusted echo reference signal from the primary acoustic signal to generate a noise and echo subtracted signal; and
outputting the noise and echo subtracted signal.

2. The method of claim 1, wherein subtracting of the desired signal component comprises applying a coefficient representing a source location to the primary acoustic signal to generate the desired signal component.

3. The method of claim 1, further comprising applying a non-linear processor to provide an additional echo cancellation in the noise and echo subtracted signal.

4. The method of claim 3, wherein the non-linear processor depends on at least a ratio of the noise and echo subtracted signal energy and the primary acoustic signal energy.

5. The method of claim 1, further comprising determining a null processing (NP) gain based on the at least one energy ratio indicating how much of the primary acoustic signal has been cancelled out of the noise and echo subtracted signal.

6. The method of claim 5, further comprising providing the NP gain to a multiplicative noise suppression system.

7. The method of claim 1, wherein the primary and secondary acoustic signals are separated into sub-band signals.

8. The method of claim 1, wherein outputting the noise subtracted signal comprises outputting the noise and echo subtracted signal to a multiplicative noise suppression system.

9. The method of claim 8, further comprising applying a gain mask to the noise and echo subtracted signal to generate an audio output signal, the gain mask being generated based at least on the noise and echo subtracted signal.

10. The method of claim 9, further comprising:
filtering the mask to suppress spectrally isolated blips; and
lower-limiting a post-mask energy of the noise and echo subtracted signal in each sub-band.

11. A system for joint suppressing noise and echo, the system comprising:
a microphone array configured to receive at least:
a primary signal;
a secondary acoustic signal; and
an echo reference signal;
an analysis module configured to generate a desired signal component to be subtracted from the secondary acoustic signal to obtain a noise component signal;
an adaptation module configured to determine a first adjusting coefficient for the noise component signal and a second adjusting coefficient for the echo reference signal, the adaption module being further configured to apply the first adjusting coefficient to the noise component signal to form an adjusted noise component signal and to apply the second adjusting coefficient to the echo reference signal to form an adjusted echo reference signal; and
at least one summing module configured to subtract the desired signal component from the secondary acoustic signal and to subtract the adjusted noise component signal and the adjusted echo reference signal from the primary acoustic signal to generate a noise and echo subtracted signal.

12. The system of claim 11, wherein the analysis module is configured to apply a coefficient representing a source location to the primary acoustic signal to generate the desired signal component.

13. The system of claim 11, further comprising a non-linear processor to perform an additional echo cancellation in the noise and echo subtracted signal.

14. The system of claim 13, wherein the non-linear processor depends on at least a ratio of the noise and echo subtracted signal energy and the primary acoustic signal energy.

15. The system of claim 11, further comprising a gain module configured to determine a null processing (NP) gain based on the at least one energy ratio indicating how much of the primary acoustic signal has been cancelled out of the noise subtracted signal.

16. A non-transitory machine readable medium having embodied thereon a program, the program providing instructions for a method for suppressing noise and echo using noise and echo subtraction processing, the method comprising:
receiving at least a primary acoustic signal and a secondary acoustic signal;
receiving an echo reference signal;
subtracting a desired signal component from the secondary acoustic signal to obtain a noise component signal;
determining an adjusting coefficient for the noise component signal and an adjusting coefficient for the echo reference signal;
applying the adjusting coefficient to the noise component signal;
applying the adjusting coefficient to the echo reference signal;
subtracting the noise component signal and echo reference signal from the primary acoustic signal to generate a noise and echo subtracted signal; and
outputting the noise and echo subtracted signal.

17. The non-transitory machine readable medium of claim 19, further comprising applying a nonlinear processor to provide an additional echo cancellation in the noise and echo subtracted signal.

18. The non-transitory machine readable medium of claim 17, wherein the non-linear processor depends on at least a ratio of the noise and echo subtracted signal energy and the primary acoustic signal energy.

19. The non-transitory machine readable medium of claim 16, wherein the method further comprises determining a null processing (NP) gain based on the at least one energy ratio indicating how much of the primary acoustic signal has been cancelled out of the noise and echo subtracted signal.

20. The non-transitory machine readable medium of claim 16, wherein the method further comprises providing the NP gain to a multiplicative noise suppression system.
